(19) United States
(12) Patent Application Publication
(10) Pub. No.: US 2022/0073070 A1
(43) Pub. Date: Mar. 10, 2022

(54) VEHICLE DRAFT MODE

(71) Applicant: Ford Global Technologies, LLC, Dearborn, MI (US)

(72) Inventors: Luke Niewiadomski, Dearborn, MI (US); Li Xu, Northville, MI (US); Austin Moore, Grosse Pointe Woods, MI (US)

(73) Assignee: Ford Global Technologies, LLC, Dearborn, MI (US)

(21) Appl. No.: 17/015,134

(22) Filed: Sep. 9, 2020

(51) Int. Cl. B60W 30/16; B60W 40/12; G06N 20/00

(52) U.S. Cl. CPC B60W 30/16; B60W 40/12; G06N 20/00; B60W 2554/4042; B60W 10/20; B60W 2552/10; B60W 2555/20; B60W 2554/406; B60W 2554/802

(57) ABSTRACT

A first fuel consumption value is determined for operating a host vehicle in a current lane on a road. A lead vehicle operating in front of the host vehicle and in a target lane on the road is identified based on a speed of the lead vehicle being greater than a first threshold and less than or equal to a second threshold. The second threshold is greater than the first threshold. A second fuel consumption value is predicted for operating the host vehicle at a specified distance behind the lead vehicle in the target lane based on the speed of the lead vehicle. The host vehicle is operated at the specified distance behind the lead vehicle in the target lane based on the predicted second fuel consumption value being greater than the first fuel consumption value.

### BACKGROUND

A vehicle can be equipped with electronic and electro-mechanical components, e.g., computing devices, networks, sensors and controllers, etc. A vehicle computer can acquire data regarding the vehicle's environment and can operate the vehicle or at least some components thereof based on the data. Vehicle sensors can provide data concerning routes to be traveled and objects to be avoided in the vehicle's environment. For example, a vehicle speed can be set and maintained according to user input and/or based on a speed and/or relative position of a reference vehicle, typically an immediately preceding vehicle.

### BRIEF DESCRIPTION OF THE DRAWINGS

FIG. 1 is a block diagram illustrating an example vehicle control system for a vehicle.

FIGS. 2A-2B are diagrams illustrating a host vehicle and exemplary lead vehicles positions relative to the host vehicle.

FIG. 2C is a diagram illustrating operating a vehicle according to the system of FIG. 1.

FIG. 3 is an example diagram of a deep neural network.

FIG. 4A is a first part of a flowchart of an example process for operating the vehicle.

FIG. 4B is a second part of the flowchart of FIG. 4A.

### DETAILED DESCRIPTION

A system includes a computer including a processor and a memory, the memory storing instructions executable by the processor to determine a first fuel consumption value for operating a host vehicle in a current lane on a road. The instructions further include instructions to identify a lead vehicle operating in front of the host vehicle and in a target lane on the road based on a speed of the lead vehicle being greater than a first threshold and less than or equal to a second threshold. The second threshold is greater than the first threshold. The instructions further include instructions to predict a second fuel consumption value for operating the host vehicle at a specified distance behind the lead vehicle in the target lane based on the speed of the lead vehicle. The instructions further include instructions to operate the host vehicle at the specified distance behind the lead vehicle in the target lane based on the predicted second fuel consumption value being greater than the first fuel consumption value.

The instructions can further include instructions to predict the second fuel consumption value additionally based on a height of the lead vehicle.

The instructions can further include instructions to identify the lead vehicle additionally based on a height of the lead vehicle.

The instructions can further include instructions to identify the lead vehicle additionally based on a distance from the host vehicle to the lead vehicle.

The instructions can further include instructions to identify the lead vehicle additionally based on a gap between the lead vehicle and a vehicle in the target lane and immediately behind the lead vehicle.

The instructions can further include instructions to identify the lead vehicle additionally based on a number of lanes between the current lane and the target lane.

The instructions can further include instructions to host vehicle sensor data into a machine learning program that identifies the lead vehicle.

The instructions can further include instructions to determine the specified distance based on the speed of the lead vehicle.

The instructions can further include instructions to determine the specified distance based on weather data.

The instructions can further include instructions to determine the specified distance based on receiving a user input in the host vehicle.

The instructions can further include instructions to enable a draft operation mode to an enabled state based on determining a speed of the host vehicle is greater than the first threshold and less than or equal to the second threshold.

The instructions can further include instructions to operate the host vehicle the specified distance behind the lead vehicle in the target lane additionally based on receiving a user input in the host vehicle selecting the draft operation mode.

The instructions can further include instructions to update host vehicle operation based on receiving another user input deselecting the draft operation mode.

The instructions can further include instructions to enable the draft operation mode to the enabled state additionally based on weather data.

The instructions can further include instructions to enable the draft operation mode to the enabled state additionally based on a traffic density on the road being below a threshold density.

A method includes determining a first fuel consumption value for operating a host vehicle in a current lane on a road. The method further includes identifying a lead vehicle operating in front of the host vehicle and in a target lane on the road based on a speed of the lead vehicle being greater than a first threshold and less than or equal to a second threshold. The second threshold is greater than the first threshold. The method further includes predicting a second fuel consumption value for operating the host vehicle at a specified distance behind the lead vehicle in the target lane based on the speed of the lead vehicle. The method further includes operating the host vehicle at the specified distance behind the lead vehicle in the target lane based on the predicted second fuel consumption value being greater than the first fuel consumption value.

The method can further include predicting the second fuel consumption value additionally based on a height of the lead vehicle.

The method can further include identifying the lead vehicle additionally based on at least one of a height of the lead vehicle, a distance from the host vehicle to the lead vehicle, a gap between the lead vehicle and a vehicle in the target lane and immediately behind the lead vehicle, or a number of lanes between the current lane and the target lane.

The method can further include determining the specified distance based on at least one of the speed of the lead vehicle, weather data, or receiving a user input in the host vehicle.

The method can further include inputting host vehicle sensor data into a machine learning program that identifies the lead vehicle.

Further disclosed herein is a computing device programmed to execute any of the above method steps. Yet further disclosed herein is a computer program product, including a computer readable medium storing instructions executable by a computer processor, to execute an of the above method steps.

A vehicle computer can control operation of a host vehicle, including by taking into account a lane of travel likely to result in efficient fuel consumption, e.g., that is more efficient than in a current lane of travel. For example, the vehicle computer can control the speed of the host vehicle based on a speed and relative position of a vehicle operating in front of the host vehicle and in a same lane of travel, e.g., to maintain at least a minimum distance between the host vehicle and the vehicle. Operating the host vehicle behind a lead vehicle can provide an aerodynamic drafting effect, which can improve fuel consumption of the host vehicle. However, when the host vehicle is achieving the aerodynamic drafting effect, a distance between the host vehicle and the lead vehicle may be less than a distance at which a user can prevent the host vehicle from impacting the lead vehicle.

Advantageously and as described herein, the vehicle computer can identify a lead vehicle based on sensor data and can predict a fuel consumption value for operating the host vehicle at a specified distance behind the lead vehicle. The vehicle computer can then move the host vehicle to the specified distance behind the lead vehicle, i.e., the vehicle computer can operate the host vehicle to draft behind the lead vehicle, when the predicted fuel consumption value for operating the host vehicle at the specified distance behind the lead vehicle is greater than the fuel consumption value for operating the host vehicle at a current position relative to the lead vehicle. Drafting behind the lead vehicle can improve fuel consumption for operating the host vehicle.

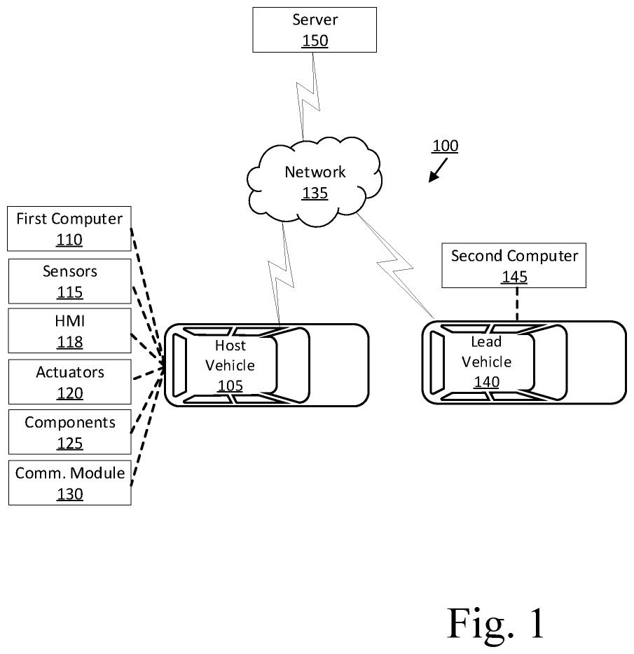

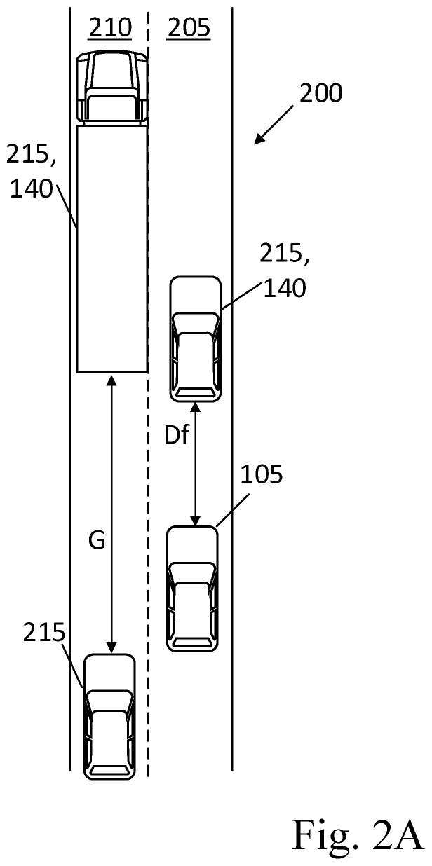

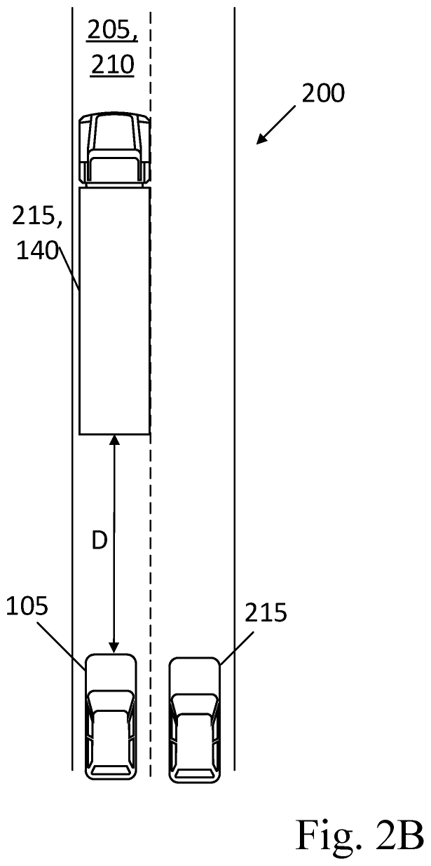

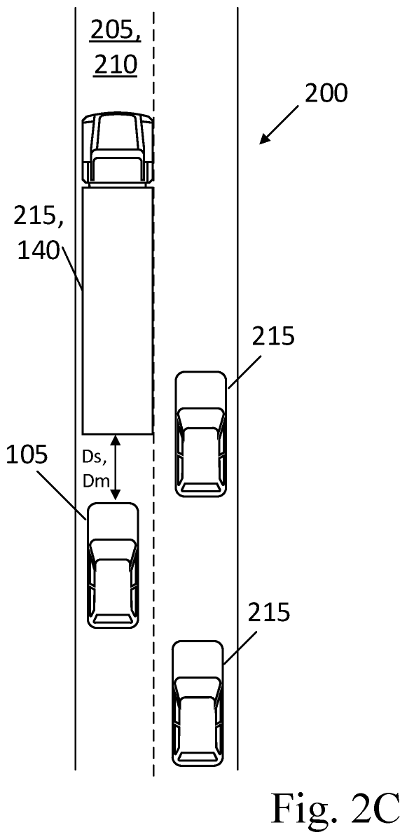

With reference to FIGS. 1-2B, an example vehicle control system 100 includes a host vehicle 105. A first computer 110 in the host vehicle 105 receives data from sensors 115. The first computer 110 is programmed to determine a first fuel consumption value for operating the host vehicle 105 in a current lane 205 on a road 200. The first computer 110 is further programmed to identify a lead vehicle 140 operating in front of the host vehicle 105 and in a target lane 210 on the road 200 based on a speed of the lead vehicle 140 being greater than a first threshold and less than or equal to a second threshold. The second threshold is greater than the first threshold. The first computer 110 is further programmed to predict a second fuel consumption value for operating the host vehicle 105 at a specified distance Ds behind the lead vehicle 140 in the target lane 210 based on the speed of the lead vehicle 140. The first computer 110 is further programmed to operate the host vehicle 105 at the specified distance Ds behind the lead vehicle 140 in the target lane 210 based on the predicted second fuel consumption value being greater than the first fuel consumption value.

Turning now to FIG. 1, the host vehicle 105 includes the first computer 110, sensors 115, actuators 120 to actuate various vehicle components 125, and a vehicle communications module 130. The communications module 130 allows the first computer 110 to communicate with a remote server computer 150 and/or other vehicles, e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135.

The first computer 110 includes a processor and a memory such as are known. The memory includes one or more forms of computer-readable media, and stores instructions executable by the first computer 110 for performing various operations, including as disclosed herein. The first computer 110 can further include two or more computing devices operating in concert to carry out host vehicle 105 operations including as described herein. Further, the first computer 110 can be a generic computer with a processor and memory as described above and/or may include a dedicated electronic circuit including an ASIC that is manufactured for a particular operation, e.g., an ASIC for processing sensor data and/or communicating the sensor data. In another example, the first computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in the first computer 110.

The first computer 110 may operate the host vehicle 105 in an autonomous, a semi-autonomous mode, or a non-autonomous (or manual) mode. For purposes of this disclosure, an autonomous mode is defined as one in which each of host vehicle 105 propulsion, braking, and steering are controlled by the first computer 110; in a semi-autonomous mode the first computer 110 controls one or two of host vehicle 105 propulsion, braking, and steering; in a non-autonomous mode a human operator controls each of host vehicle 105 propulsion, braking, and steering.

The first computer 110 may include programming to operate one or more of host vehicle 105 brakes, propulsion (e.g., control of acceleration in the host vehicle 105 by controlling one or more of an internal combustion engine, electric motor, hybrid engine, etc.), steering, transmission, climate control, interior and/or exterior lights, horn, doors, etc., as well as to determine whether and when the first computer 110, as opposed to a human operator, is to control such operations.

The first computer 110 may include or be communicatively coupled to, e.g., via a vehicle communications network such as a communications bus as described further below, more than one processor, e.g., included in electronic controller units (ECUs) or the like included in the host vehicle 105 for monitoring and/or controlling various vehicle components 125, e.g., a transmission controller, a brake controller, a steering controller, etc. The first computer 110 is generally arranged for communications on a vehicle communication network that can include a bus in the host vehicle 105 such as a controller area network (CAN) or the like, and/or other wired and/or wireless mechanisms.

Via the host vehicle 105 network, the first computer 110 may transmit messages to various devices in the host vehicle 105 and/or receive messages (e.g., CAN messages) from the various devices, e.g., sensors 115, an actuator 120, ECUs, etc. Alternatively, or additionally, in cases where the first computer 110 actually comprises a plurality of devices, the vehicle communication network may be used for communications between devices represented as the first computer 110 in this disclosure. Further, as mentioned below, various controllers and/or sensors 115 may provide data to the first computer 110 via the vehicle communication network.

Host vehicle 105 sensors 115 may include a variety of devices such as are known to provide data to the first computer 110. For example, the sensors 115 may include Light Detection And Ranging (LIDAR) sensor(s) 115, etc., disposed on a top of the host vehicle 105, behind a host vehicle 105 front windshield, around the host vehicle 105, etc., that provide relative locations, sizes, and shapes of objects surrounding the host vehicle 105. As another example, one or more radar sensors 115 fixed to host vehicle 105 bumpers may provide data to provide locations of the objects, second vehicles, etc., relative to the location of the host vehicle 105. The sensors 115 may further alternatively or additionally, for example, include camera sensor(s) 115, e.g. front view, side view, etc., providing images from an area surrounding the host vehicle 105. In the context of this disclosure, an object is a physical, i.e., material, item that has mass and that can be represented by physical phenomena (e.g., light or other electromagnetic waves, or sound, etc.) detectable by sensors 115. Thus, the host vehicle 105 and the lead vehicle 140, as well as other items including as discussed below, fall within the definition of “object” herein.

The first computer 110 is programmed to receive data from one or more sensors 115 substantially continuously, periodically, and/or when instructed by a remote server computer 150, etc. The data may, for example, include a location of the host vehicle 105. Location data specifies a point or points on a ground surface and may be in a known form, e.g., geo-coordinates such as latitude and longitude coordinates obtained via a navigation system, as is known, that uses the Global Positioning System (GPS). Additionally, or alternatively, the data can include a location of an object, e.g., a vehicle, a sign, a tree, etc., relative to the host vehicle 105. As one example, the data may be image data of the environment around the host vehicle 105. In such an example, the image data may include one or more objects and/or markings, e.g., lane markings, on or along the current road 200. Image data herein means digital image data, e.g., comprising pixels with intensity and color values, that can be acquired by camera sensors 115. The sensors 115 can be mounted to any suitable location in or on the host vehicle 105, e.g., on a host vehicle 105 bumper, on a host vehicle 105 roof, etc., to collect images of the environment around the host vehicle 105.

The host vehicle 105 actuators 120 are implemented via circuits, chips, or other electronic and or mechanical components that can actuate various vehicle subsystems in accordance with appropriate control signals as is known. The actuators 120 may be used to control components 125, including braking, acceleration, and steering of a host vehicle 105.

In the context of the present disclosure, a vehicle component 125 is one or more hardware components adapted to perform a mechanical or electro-mechanical function or operation—such as moving the host vehicle 105, slowing or stopping the host vehicle 105, steering the host vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component 125 (e.g., that may include one or more of a damper, e.g., a shock or a strut, a bushing, a spring, a control arm, a ball joint, a linkage, etc.), a brake component, a park assist component, an adaptive cruise control component, an adaptive steering component, one or more passive restraint systems (e.g., airbags), a movable seat, etc.

The host vehicle 105 further includes a human-machine interface (HMI) 118. The HMI 118 includes user input devices such as knobs, buttons, switches, pedals, levers, touchscreens, and/or microphones, etc. The input devices may include sensors 115 to detect user inputs and provide user input data to the first computer 110. That is, the first computer 110 may be programmed to receive user input from the HMI 118. The user may provide each user input via the HMI 118, e.g., by pressing a virtual button on a touchscreen display, by providing voice commands, etc. For example, a touchscreen display included in an HMI 118 may include sensors 115 to detect that a user pressed a virtual button on the touchscreen display to, e.g., select or deselect a vehicle operation mode, such as an eco-mode, a sport mode, a draft mode, etc., which input can be received in the first computer 110 and used to determine the selection of the user input.

The HMI 118 typically further includes output devices such as displays (including touchscreen displays), speakers, and/or lights, etc., that output signals or data to the user. The HMI 118 is coupled to the vehicle communications network and can send and/or receive messages to/from the first computer 110 and other vehicle sub-systems.

In addition, the first computer 110 may be configured for communicating via a vehicle-to-vehicle communication module 130 or interface with devices outside of the host vehicle 105, e.g., through a vehicle-to-vehicle (V2V) or vehicle-to-infrastructure (V2X) wireless communications (cellular and/or DSRC, etc.) to another vehicle, and/or to a remote server computer 150 (typically via direct radio frequency communications). The communications module 130 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth, IEEE 802.11, dedicated short range communications (DSRC), and/or wide area networks (WAN), including the Internet, providing data communication services.

The network 135 represents one or more mechanisms by which a first computer 110 may communicate with remote computing devices, e.g., the remote server computer 150, another vehicle computer, etc. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The lead vehicle 140 may include a second, i.e., lead vehicle, computer 145. The second computer 145 includes a second processor and a second memory such as are known. The second memory includes one or more forms of computer-readable media, and stores instructions executable by the second computer 145 for performing various operations, including as disclosed herein.

Additionally, the lead vehicle 140 may include sensors, actuators to actuate various vehicle components, and a vehicle communications module. The sensors, actuators to actuate various vehicle components, and the vehicle communications module typically have features in common with the sensors 115, actuators 120 to actuate various host vehicle components 125, and the vehicle communications module 130, and therefore will not be described further to avoid redundancy.

The remote server computer 150 can be a conventional computing device, i.e., including one or more processors and one or more memories, programmed to provide operations such as disclosed herein. Further, the remote server computer 150 can be accessed via the network 135, e.g., the Internet, a cellular network, and/or or some other wide area network.

Turning now to FIGS. 2A-2B, FIGS. 2A and 2B are diagrams illustrating a host vehicle 105 operating in a current lane 205 of an example road 200. A lane is a specified area of the road for vehicle travel. A road in the present context is an area of ground surface that includes any surface provided for land vehicle travel. A lane of a road is an area defined along a length of a road, typically having a width to accommodate only one vehicle, i.e., such that multiple vehicles can travel in a lane one in front of the other, but not abreast of, i.e., laterally adjacent, one another.

The first computer 110 is programmed to identify a current lane 205, i.e., a lane in which the host vehicle 105 is operating, on the road 200. For example, the first computer 110 can receive map data and/or location data, e.g., GPS data, from a remote server computer 150 specifying the current lane 205. As another example, the first computer 110 may identify the current lane 205 based on sensor 115 data. That is, the first computer 110 can be programmed to receive sensor 115 data, e.g., camera image data, from sensors 115 and to implement various image processing techniques to identify the current lane 205. For example, lanes can be indicated by markings, e.g., painted lines on the road 200, and image recognition techniques, such as are known, can be executed by the first computer 110 to identify the current lane 205. For example, the first computer 110 can identify solid lane markings on opposite sides of the host vehicle 105. The first computer 110 can then identify the current lane 205 of host vehicle 105 operation based on a number of groups of dashed lane markings between each side of the host vehicle 105 and the respective solid lane marking. A solid lane marking is a marking extending substantially continuously, i.e., that is unbroken, along a length of a road and defining at least one boundary of a lane. A group of dashed lane markings includes a plurality of markings spaced from each other along a length of a road and defining at least one boundary of a lane. Additionally, the first computer 110 can determine a number of lanes on the road 200 based on the number of groups of dashed lane markings (e.g., the number of lanes is one more than the number of groups of dashed lane markings).

The first computer 110 can, for example, generate a planned path to operate the host vehicle 105 on the road 200, e.g., in the current lane 205. Alternatively, the remote server computer 150 can generate the planned path and provide the planned path to the first computer 110, e.g., via the network 135. As used herein, a “path” is a set of points, e.g., that can be specified as coordinates with respect to a vehicle coordinate system and/or geo-coordinates, that the first computer 110 is programmed to determine with a conventional navigation and/or path planning algorithm. A path can be specified according to one or more path polynomials. A path polynomial is a polynomial function of degree three or less that describes the motion of a vehicle on a ground surface. Motion of a vehicle on a roadway is described by a multi-dimensional state vector that includes vehicle location, orientation, speed, and acceleration. Specifically, the vehicle motion vector can include positions in x, y, z, yaw, pitch, roll, yaw rate, pitch rate, roll rate, heading velocity and heading acceleration that can be determined by fitting a polynomial function to successive 2D locations included in the vehicle motion vector with respect to the ground surface, for example.

Further for example, the path polynomial p(x) is a model that predicts the path as a line traced by a polynomial equation. The path polynomial p(x) predicts the path for a predetermined upcoming distance x, by determining a lateral coordinate p, e.g., measured in meters:

p(x)=a₀a₁x+a₂x²+aₓ³ (1)

where a₀ an offset, i.e., a lateral distance between the path and a center line of the host vehicle 105 at the upcoming distance x, a₁ is a heading angle of the path, a₂ is the curvature of the path, and a₃ is the curvature rate of the path.

While operating in the current lane 205, the first computer 110 can receive sensor 115 data, e.g., image data, of the environment around the host vehicle 105 in the current lane 205. The image data can include one or more objects 215 around the host vehicle 105. For example, object classification or identification techniques, can be used, e.g., in the first computer 110 based on lidar sensor 115, camera sensor 115, etc., data to identify a type of object 215, e.g., a vehicle, a bicycle, a drone, etc., as well as physical features of objects.

Various techniques such as are known may be used to interpret sensor 115 data and/or to classify objects 215 based on sensor 115 data. For example, camera and/or lidar image data can be provided to a classifier that comprises programming to utilize one or more conventional image classification techniques. For example, the classifier can use a machine learning technique in which data known to represent various objects 215, is provided to a machine learning program for training the classifier. Once trained, the classifier can accept as input vehicle sensor 115 data, e.g., an image, and then provide as output, for each of one or more respective regions of interest in the image, an identification and/or a classification (i.e., movable or non-movable) of one or more objects 215 or an indication that no object is present in the respective region of interest. Further, a coordinate system (e.g., polar or cartesian) applied to an area proximate to the host vehicle 105 can be used to specify locations and/or areas (e.g., according to the host vehicle 105 coordinate system, translated to global latitude and longitude geo-coordinates, etc.) of objects 215 identified from sensor 115 data. Yet further, the first computer 110 could employ various techniques for fusing (i.e., incorporating into a common coordinate system or frame of reference) data from different sensors 115 and/or types of sensors 115, e.g., lidar, radar, and/or optical camera data.

The first computer 110 is programmed to operate the host vehicle 105 based on an operation mode. That is, the first computer 110 may actuate one or more host vehicle components 125 based on the operation mode. The operation mode specifies operating parameters, i.e., a measurable set of physical parameters, for one or more vehicle components 125, such as a braking, steering, propulsion, etc. For example, the operation mode may be a draft operation mode. In the draft operation mode, the first computer 110 is programmed to operate the host vehicle 105 at a specified distance Ds behind a lead vehicle 140 in a target lane 210. The specified distance Ds may be determined (as discussed below) such that the host vehicle 105 achieves an aerodynamic drafting effect from the lead vehicle 140. That is, the first computer 110 may actuate one or more host vehicle components 125 to control the host vehicle 105, e.g., apply brakes, propel the host vehicle 105, etc., to maintain the host vehicle 105 the specified distance Ds behind the lead vehicle 140 in the target lane 210, i.e., to draft behind the lead vehicle 140. Other non-limiting examples of operation modes include “Sport mode,” “Track mode,” “Eco mode,” “Comfort mode,” “Aero mode,” “Park mode,” etc.

The first computer 110 is programmed to transition the draft operation mode between a disabled state and an enabled state based on a speed of the host vehicle 105. The first computer 110 can determine the speed of the host vehicle 105 based on sensor 115 data, e.g., wheel speed sensor data. Upon determining the speed of the host vehicle 105, the first computer 110 can compare the speed of the host vehicle 105 to a first threshold. The first threshold specifies a speed above which the first computer 110 enables the draft operation mode. The first threshold may be determined empirically, e.g., based on determining vehicle speed at which achieving an aerodynamic drafting effect can improve fuel efficiency.

Additionally, the first computer 110 can compare the speed of the host vehicle to a second threshold. The second threshold is a speed above which the first computer 110 disables the draft operation mode. The second threshold may be determined empirically, e.g., based on determining a distance from a lead vehicle 140 at which the host vehicle 105 is to be operated to achieve an aerodynamic drafting effect is less than a minimum distance from the lead vehicle 140 at which the first computer 110 can prevent the host vehicle 105 from impacting the lead vehicle 140. The second threshold is greater than the first threshold. When the speed of the host vehicle 105 is between the first threshold and the second threshold, the first computer 110 can enable the draft operation mode. When the speed of the host vehicle 105 is less than or equal to the first threshold or greater than or equal to the second threshold, the first computer 110 can disable the draft operation mode.

Additionally, or alternatively, the first computer 110 can be programmed to transition the draft operation mode between the disabled state and the enabled state based on a traffic density of the road 200. Traffic density is a number of vehicles per unit distance along a length of a road, e.g., a number of vehicles per kilometer. The first computer 110 can determine the traffic density of the road 200 based on sensor 115 data. For example, the first computer 110 can receive sensor 115 data, e.g., image data, of the environment around the host vehicle 105, as discussed above. The first computer 110 can then count the number of vehicles traveling in the same direction as the host vehicle 105 along a section of the road 200, e.g., using image processing techniques, and divide that number by the length of the section of the road 200. The first computer 110 can determine the length of the section based on fields of view of the sensors 115, e.g., stored in a memory of the first computer 110. As another example, the first computer 110 can receive the traffic density of the road 200 from the remote server computer 150, e.g., via the network 135.

Upon determining the traffic density of the road 200, the first computer 110 can compare the traffic density to a threshold density. The threshold density is chosen to indicate congested traffic. For example, the threshold density can be chosen to be sufficiently high that the speed of traffic is decreasing as a result of the traffic density, i.e., to correspond to a saturation point (as discussed below) of the traffic density. In such an example, operating the host vehicle 105 at a specified distance Ds (FIG. 2C) behind a lead vehicle 140 may not achieve an aerodynamic drafting effect that improves fuel efficiency. The threshold density corresponds to the predetermined saturation point for the number of lanes in the first direction along the road 200, and the threshold density is stored in the memory of the first computer 110. If the traffic density is less than the threshold density, the first computer 110 can enable the draft operation mode. If the traffic density is greater than or equal to the threshold density, the first computer 110 disables the draft operation mode.

In general, as traffic density increases, average speed of traffic remains constant until the traffic density reaches a saturation point, which is defined as a traffic density beyond which the speed of traffic (i.e., average speed of vehicles at a point on a road) decreases. The saturation point typically depends on the number of lanes of traffic in a direction and can be determined experimentally by observing the road 200 over time, i.e., by gathering empirical data. The saturation point is a predetermined quantity for a given road 200, direction, and number of lanes in that direction. The saturation point can be experimentally, i.e., empirically, determined by making many observations of the number of vehicles on the road 200 and the speeds of the vehicles, from which traffic density and average speed can be calculated.

Additionally, or alternatively, the first computer 110 can be programmed to transition the draft operation mode between the disabled state and the enabled state based on weather data. For example, the first computer 110 can receive weather data from the remote server computer 150, e.g., via the network 135. The weather data may be in a known form, e.g., ambient air temperature, ambient humidity, precipitation information, forecasts, wind speed, etc. That is, the weather data may specify physical phenomenon in an ambient environment, e.g., an air temperature, a wind speed and/or direction, an amount of ambient light, a presence or absence of precipitation, a type of precipitation (e.g., snow, rain, etc.), an amount of precipitation (e.g., a volume or depth of precipitation being received per unit of time, e.g., amount of rain per minute or hour), presence or absence of atmospheric occlusions that can affect visibility, e.g., fog, smoke, dust, smog, a level of visibility (e.g., on a scale of 0 to 1, 0 being no visibility and 1 being unoccluded visibility), etc. As another example, the first computer 110 can receive and analyze sensor 115 data, e.g., image data, to determine weather data for the environment around the vehicle, e.g., using image processing techniques. The first computer 110 can, for example, disable the draft operation mode based on weather data indicating a presence of precipitation and enable the draft operation mode based on weather data indicating an absence of precipitation.

When the draft operation mode is in the enabled state, the first computer 110 enables user selection of the draft operation mode. For example, the first computer 110 may actuate the HMI 118 to detect a first user input selecting the draft operation mode. For example, the HMI 118 may be programmed to display a virtual button on a touchscreen display that the user can press to select the draft operation mode. As another example, the HMI 118 may be programmed to provide a virtual button or the like, which is non-selectable when the draft operation mode is in the disabled state, selectable via the touchscreen display when the draft operation mode is in the enabled state. In other words, the HMI 118 may activate sensors 115 that can detect the user pressing the virtual button to select the draft operation mode. Upon detecting the first user input, the HMI 118 can then provide the first user input to the first computer 110, and the first computer 110 can select the draft operation mode based on the first user input.

Additionally, the first computer 110 may actuate the HMI 118 to detect a second user input deselecting the draft operation mode. For example, the HMI 118 may be programmed to display a virtual button on a touchscreen display that the user can press to deselect the draft operation mode. In other words, the HMI 118 may activate sensors 115 that can detect the user pressing the virtual button to deselect the draft operation mode. Upon detecting the second user input, the HMI 118 can then provide the second user input to the first computer 110, and the first computer 110 can deselect the draft operation mode based on the first user input.

When the draft operation mode is in the disabled state, the first computer 110 may actuate the HMI 118 to disable detection of the first user input. Said differently, the first computer 110 prevents the user from selecting the draft operation mode in the disabled state. For example, the HMI 118 may be programmed to remove a virtual button from the touchscreen display. As another example, the HMI 118 may be programmed to make the virtual button non-selectable. In other words, the HMI 118 may deactivate sensors 115 that can detect the user pressing the virtual button to select the draft operation mode.

When the draft operation mode is in the disabled state or deselected, the first computer 110 may be programmed to maintain at least a following distance Df (FIG. 2B) between the host vehicle 105 and a vehicle in front of the host vehicle 105 and in the current lane 205. That is, the first computer 110 may actuate one or more host vehicle components 125 to control the host vehicle 105, e.g., apply brakes, propel the host vehicle 105, etc., to maintain at least the following distance Df from vehicle in front of the host vehicle 105. For example, upon deselecting the draft operation mode, the first computer 110 may update the host vehicle 105 operation to increase a distance between the host vehicle 105 and a lead vehicle 140 from the specified distance Ds to at least the following distance Df. The following distance Df may be determined empirically, e.g., based on a distance at which the first computer 110 can control the host vehicle 105 to prevent the host vehicle 105 from impacting the lead vehicle 140 (e.g., based on a speed of the host vehicle 105, a speed of the lead vehicle 140, etc.). The following distance Df may be greater than the specified distance Ds.

Upon selecting the draft mode, the first computer 110 can identify, e.g., via image data, an object 215 around the host vehicle 105, e.g., on the road 200, as discussed above. Upon identifying the object 215 as a vehicle, the first computer 110 can be programmed to identify the vehicle 215 as a lead vehicle 140 based on a longitudinal position of the vehicle. A lead vehicle 140 in the present context is a vehicle operating on the road 200 and forward of the host vehicle 105. The first computer 110 may determine the longitudinal position of the identified vehicle 215 based on sensor 115 data. For example, the first computer 110 may determine the identified vehicle 215 is forward of the host vehicle 105 based on image data from a forward-facing camera. Forward of the host vehicle 105 means that a rearmost point of the identified vehicle 215 is forward of a frontmost point of the host vehicle 105.

As another example, the classifier can be further trained with data known to represent various longitudinal positions. Thus, in addition to identifying the object 215 as a vehicle, the classifier can output an identification of a lead vehicle 140 based on the longitudinal position of the identified vehicle 215. Once trained, the classifier can accept as input host vehicle sensor 115 data, e.g., an image, and then provide as output for each of one or more respective regions of interest in the image, an identification of a lead vehicle 140 based on the identified vehicle 215 being forward of the host vehicle 105, or that no lead vehicle 140 is present in the respective region of interest based on detecting no vehicle forward of the host vehicle 105.

Additionally, or alternatively, the first computer 110 may be programmed to identify the identified vehicle 215 as a lead vehicle 140 based on a speed of the identified vehicle 215. For example, the first computer 110 can compare the speed of the identified vehicle 215 to the first and second thresholds (as discussed above). When the speed of the identified vehicle 215 is between the first and second thresholds, the first computer 110 can identify the identified vehicle 215 as a lead vehicle 140.

The first computer 110 may be programmed to determine a speed of the identified vehicle 215 based on sensor 115 data. The first computer 110 may determine the speed of the identified vehicle 215 relative to the host vehicle 105 by determining a change in distance between the identified vehicle 215 and the host vehicle 105 over time. For example, the first computer 110 determine the speed of the identified vehicle 215 relative to the host vehicle 105 with the formula ΔD/ΔT, where ΔD is a difference between a pair of distances from the host vehicle 105 to the identified vehicle 215 (as discussed above) taken at different times and ΔT is an amount of time between when the pair of distances was determined. For example, the difference between the pair of distances ΔD may be determined by subtracting the distance determined earlier in time from the distance determined later in time. In such an example, a positive value indicates that the identified vehicle 215 is traveling slower than the host vehicle 105, and a negative value indicates that the identified vehicle 215 is traveling faster than the host vehicle 105. The first computer 110 can then combine, i.e., add, the speed of the identified vehicle 215 relative to the host vehicle 105 and the speed of the host vehicle 105. The combined speed is the speed of the identified vehicle 215 with respect to the road 200. As another example, the first computer 110 may receive the speed of the identified vehicle 215, e.g., via V2V communications.

Additionally, or alternatively, the first computer 110 can identify the identified vehicle 215 as a lead vehicle 140 based on a height of the identified vehicle 215. For example, the first computer 110 can compare the height of the identified vehicle 215 to a height of the host vehicle 105, e.g., stored in a memory of the first computer 110. When the height of the identified vehicle 215 is greater than or equal to the height of the host vehicle 105, the first computer 110 can identify the identified vehicle 215 as a lead vehicle 140.

The first computer 110 can determine the height of the identified vehicle 215 based on sensor 115 data. For example, the classifier can be further trained with data known to represent various types, e.g., makes and/or models, of vehicles. Thus, in addition to identifying the identified vehicle 215, the classifier can output a type of the identified vehicle 215. Once trained, the classifier can accept as input host vehicle sensor 115 data, e.g., an image including the identified vehicle 215, and then provide as output an identification of the type of the identified vehicle 215 in the image. As another example, the first computer 110 can determine a type of the identified vehicle 215 based on image data, e.g., by using image recognition techniques. The first computer 110 can then determine one or more vehicle parameters, e.g., dimensions (e.g., height, length, width), a turning radius, a wheelbase, etc., based on the type of the identified vehicle 215. For example, the first computer 110 may store, e.g., in a memory, a look-up table or the like that associates vehicle parameters with a type of vehicle 215. As another example, the first computer 110 can receive the height of the identified vehicle 215, e.g., via V2V communications.

Additionally, or alternatively, the first computer 110 can be programmed to identify the identified vehicle 215 as a lead vehicle 140 based on a distance D from the host vehicle 105 to the identified vehicle 215 (see FIG. 2B. For example, the first computer 110 can compare the distance D to a threshold distance. The threshold distance specifies a maximum distance within which the first computer 110 can identify a vehicle as a lead vehicle 140. The threshold distance may be determined empirically, e.g., based on the host vehicle 105 being able to operate from a current position relative to the vehicle to the specified distance Ds behind the vehicle within a time period and without exceeding a speed limit. When the distance D is less than or equal to the threshold distance, the first computer 110 can identify the identified vehicle 215 as a lead vehicle 140.

The first computer 110 may determine the distance D from the host vehicle 105 to the identified vehicle 215 based on sensor 115 data. For example, a lidar sensor 115, which is similar to a radar sensor 115, uses laser light transmissions (instead of radio transmissions) to obtain reflected light pulses from objects, e.g., the identified vehicle 215. The reflected light pulses can be measured to determine object distances. Data from the lidar sensor 115 can be provided to generate a three-dimensional representation of detected objects, sometimes referred to as a point cloud.

Additionally, or alternatively, the first computer 110 can be programmed to identify the identified vehicle 215 as a lead vehicle 140 based on a gap G (FIG. 2A) between the identified vehicle 215 and another vehicle immediately behind the identified vehicle 215 and in the target lane 210 (see FIG. 2A). For example, the first computer 110 can compare the gap G to a threshold gap. The threshold gap specifies a minimum distance of free space behind an identified vehicle, such that the first computer 110 can maneuver the host vehicle 105 to the specified distance Ds behind the identified vehicle in the target lane 210 and not impact the identified vehicle or the vehicle immediately behind the identified vehicle. The threshold gap may be determined empirically, e.g., based on the specified distance Ds, a length of the host vehicle 105, and a minimum distance of free space behind the host vehicle 105 to prevent the host vehicle 105 from being impacted (e.g., based on a speed of the host vehicle 105). When the gap G is greater than or equal to the threshold gap, the first computer 110 can identify the identified vehicle 215 as a lead vehicle 140.

The first computer 110 may determine the gap G based on sensor 115 data. For example, the first computer 110 can employ free space computation techniques to image data that identifies a range of pixel coordinates associated with a vehicle 215 and free space (i.e., space in which no object is detected) between the host vehicle 105 and the identified vehicle 215. By identifying a set of pixel coordinates in an image associated with the free space and the identified vehicle 215 and determining a distance (in pixel coordinates) from an image sensor 115 lens, e.g., across the free space, to the identified vehicle 215 pixel coordinates, the first computer 110 can then determine a distance, e.g., across the free space, of the image sensor 115 lens from the identified vehicle 215. That is, according to known techniques, the first computer 110 can determine a distance from the lens to the identified coordinates (in pixel coordinates) and can further determine, from the image an angle between a line from the sensor 115 lens to a point on the identified vehicle 215, and an axis extending from the lens parallel to a longitudinal axis of the host vehicle 105. Then, using trigonometric functions based on (i) a line extending from the sensor 115 lens to the point on the identified vehicle 215, (ii) a line extending from the sensor 115 lens along the axis, and (iii) a line that intersects the point on the identified vehicle 215 and with which the line extending along the axis forms a right angle, the first computer 110 can determine a length of the line drawn parallel to the host vehicle 105 longitudinal axis from (a) an axis extending from the sensor 115 lens parallel to a lateral axis of the host vehicle 105 to (b) the point on the identified vehicle 215. By repeating this process for the vehicle immediately behind the identified vehicle 215 and subtracting the lengths of two lines parallel to the host vehicle 105 longitudinal axis and drawn from the axis extending from the sensor 115 lens parallel to the lateral axis of the vehicle 105 to the respective points on the vehicles, the gap G may be determined.

Additionally, or alternatively, the first computer 110 can identify the identified vehicle 215 as a lead vehicle 140 based on a number of lanes between the target lane 210, i.e., a lane in which the identified vehicle 215 is operating, and the current lane 205. The first computer 110 is programmed to identify the target lane 210 on the road 200. For example, the first computer 110 may determine the target lane 210 by using image data to identify lane markings on each side of the lead vehicle 140, e.g., according to image processing techniques, as discussed above. As another example, the first computer 110 may receive location data for the identified vehicle, e.g., via V2V communications, specifying the target lane 210. The first computer 110 may compare the number of lanes between the target lane 210 and the current lane 205 to a threshold. The threshold specifies a maximum number of lanes between the current lane 205 and the target lane 210 within which the first computer 110 can identify a vehicle as a lead vehicle 140. The threshold may be determined empirically, e.g., based on determining a number of lane changes beyond which the speed of traffic decreases (e.g., based on a number of lanes in a direction on the road 200 and a number of vehicles on the road 200). The threshold may be stored, e.g., in the memory of the first computer 110. When the number of lanes between the target lane 210 and the current lane 205 is less than the threshold, the first computer 110 can identify the identified vehicle 215 as a lead vehicle 140.

The target lane 210 may, for example, be a different lane than the current lane 205 (see FIG. 2A). That is, the lead vehicle 140 and the host vehicle 105 may be operating in different lanes. In such an example, the first computer 110 can determine the target lane 210 is different than the current lane 205 when the number of lanes on each side of the identified vehicle 215 is different than the number of lanes on the respective side of the host vehicle 105. As another example, the target lane 210 may be a same lane as the current lane 205 (see FIG. 2B). That is, the lead vehicle 140 and the host vehicle 105 may be operating in the same lane. In such an example, the first computer 110 can determine the identified vehicle 215 is in the current lane 205, i.e., the target lane 210 and the current lane 205 are the same lane, when the number of lanes on each side of the identified vehicle 215 is the same as the number of lanes on the respective side of the host vehicle 105. The first computer 110 can determine the number of lanes between the target lane 210 and the current lane 205 by subtracting the number of lanes detected on one side of the identified vehicle 215 from the number of lanes detected on the respective side of the host vehicle 105.

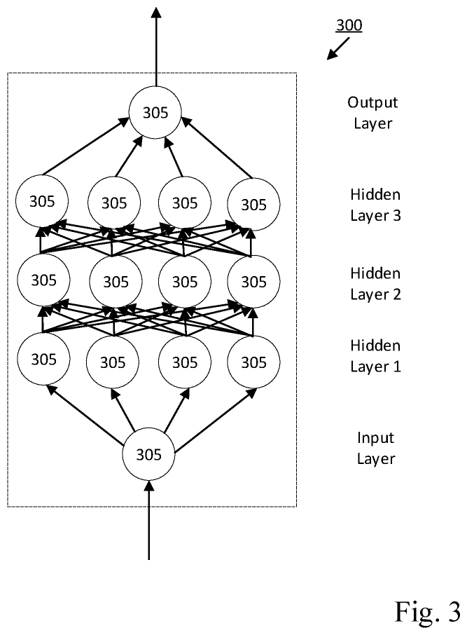

As another example, the first computer 110 can input sensor 115 data, e.g., image data including the identified vehicle 215, into a neural network, such as a Deep Neural Network (DNN) (see FIG. 3), that can be trained to accept image data for an vehicle 215 as input and generate an output identifying the identified vehicle 215 as a lead vehicle 140.

The first computer 110 can identify one or more vehicles 215 as a lead vehicle 140. In the situation that the first computer 110 identifies a plurality of vehicles 215 as lead vehicles 140 (see FIG. 2A), the first computer 110 can be programmed to select one lead vehicle 140. For example, the first computer 110 can select one lead vehicle 140 from a plurality of lead vehicles 140 based on Equation 2 below:

Pᵢ=c₁Dᵢ+c₂lᵢ+c₃Gᵢ+c₄hᵢ (2)

where i is a candidate lead vehicle delineator from i=1 to i=j, j is the total number of identified lead vehicles, P is a preference metric, c₁, c₂, c₃, c₄ are coefficients determined empirically, e.g., based on making many observations to identify a lead vehicle 140, l is a number of lanes between the current lane 205 and the target lane 210, and h is the height of the identified lead vehicle 140 relative to the height of the host vehicle 105. The first computer 110 can select the lead vehicle 140 with the maximum preference metric.

The first computer 110 can determine a first fuel consumption value for operating the host vehicle 105 in the current lane 205. A fuel consumption value is an amount of fuel consumed per distance traveled, e.g., miles per gallon (mpg). The first computer 110 can determine the first fuel consumption value by measuring, e.g., via sensor 115 data, an amount of fuel consumed while operating in the current lane 205 and dividing the amount of fuel consumed by the distance traveled in the current lane 205 while measuring the fuel consumption. In the case that the host vehicle 105 is propelled by an internal combustion engine, an amount of fuel is a volume of fluid fuel, e.g., gasoline. In the case that the host vehicle 105 is propelled by an electric engine, an amount of fuel is an amount of electric charge spent by the battery. In such an example, the first computer 110 can use known electric discharge conversion rates to equivalent fluid fuel volumes to determine the fuel consumption, e.g., 33.7 kWh of electricity=1 gallon of gasoline, etc.

Turning now to FIG. 2C, upon identifying the lead vehicle 140, the first computer 110 can determine the specified distance Ds at which to operate the host vehicle 105 behind the lead vehicle 140. For example, the first computer 110 can determine the specified distance Ds based on Equation 3 below:

Ds=max{Dm, (c_{w}*v*rt+Dc)} (3)

where Dm is a minimum distance, c_{w} is a coefficient for weather conditions, v is the speed of the lead vehicle 140, rt is a reaction time for the first computer 110, and Dc is a distance cushion. For example, the specified distance Ds can be the minimum distance Dm, as shown in FIG. 2C

The first computer 110 can be programmed to determine the minimum distance Dm based on one or more host vehicle 105 parameters. The minimum distance Dm is a linear distance between the host vehicle 105 and the lead vehicle 140. The first computer 110 may select a minimum distance Dm from a plurality of minimum distances Dm, e.g., stored in a look-up table or the like, corresponding to parameters, e.g., speed, weight, dimensions, etc., of the host vehicle 105. The look-up table may be stored in a memory of the first computer 110. The minimum distance Dm may be determined empirically, e.g., based on a minimum distance at which the first computer 110 can control the host vehicle 105 to prevent the host vehicle 105 from impacting the lead vehicle 140 (e.g., based on a speed of the host vehicle 105, a speed of the lead vehicle 140, etc.). The minimum distance Dm is less than the following distance Df.

The coefficient for weather conditions c_{w} is a scalar value, e.g., a number between 0 and 1, that indicates an impact of weather conditions on host vehicle 105 operation. The first computer 110 may select a coefficient for weather conditions c_{w} from a plurality of coefficients for weather conditions c_{w}, e.g., stored in a look-up table, corresponding to parameters, e.g., speed, weight, dimensions, etc., of the host vehicle 105. The look-up table may be stored in a memory of the first computer 110. The coefficients for weather conditions c_{w} may be determined empirically, e.g., based on determining a distance within which the first computer 110 can stop the host vehicle 105 (e.g., due to reduced friction between the road 200 and wheels of the host vehicle 105 and/or reduced sensor 115 visibility caused by precipitation).

The reaction time rt is an amount of time required for the first computer 110 to actuate a vehicle component 125 based on sensor 115 data. The first computer 110 may select a reaction time rt from a plurality of reaction times rt, e.g., stored in a look-up table, corresponding to a speed of the host vehicle 105. The look-up table may be stored in a memory of the first computer 110. The reaction time rt may be determined empirically, e.g., based on an amount of time for the first computer 110 to receive and analyze sensor 115 data and to then actuate vehicle components 125 to control the host vehicle 105.

The distance cushion Dc (as mentioned above) is a predetermined distance from the host vehicle 105 to the lead vehicle 140, e.g., stored in a memory of the first computer 110. The first computer 110 may select the distance cushion Dc from a plurality of distance cushions Dc, e.g., stored in a look-up table, corresponding to a fuel consumption improvement value. The look-up table may be stored in a memory of the first computer 110. The distance cushion Dc may be determined empirically, e.g., based on determining a distance behind a lead vehicle 140 a host vehicle 105 must travel to achieve an aerodynamic drafting effect that improves fuel consumption by a specified amount as compared to when the host vehicle 105 operates without achieving the aerodynamic drafting effect.

The first computer 110 can determine a fuel consumption improvement value based on a user input. The fuel consumption improvement value specifies a fuel consumption value that is greater than a current fuel consumption value (as discussed below) for the host vehicle 105. The fuel consumption improvement value may, for example, be specified as a percentage of the current fuel consumption value. When the draft operation mode is selected, the first computer 110 can enable user selection of a fuel consumption improvement value from a plurality of fuel consumption improvement values. For example, the first computer 110 may actuate the HMI 118 to detect a user input selecting a fuel consumption improvement value. For example, the HMI 118 may be programmed to display virtual buttons or the like on a touchscreen display that the user can press to select a corresponding fuel consumption improvement value. As another example, the HMI 118 may be programmed to provide virtual buttons or the like that are non-selectable when the draft operation mode is deselected and/or in the disabled state, selectable via the touchscreen display when the draft operation mode is selected. In other words, the HMI 118 may activate sensors 115 that can detect the user pressing the virtual button to select the corresponding fuel consumption improvement value. Upon detecting the user input, the HMI 118 can then provide the user input to the first computer 110, and the first computer 110 can select the distance cushion Dc based on the user input.

Upon determining the specified distance Ds, the first computer 110 can predict a second fuel consumption value for operating the host vehicle 105 at the specified distance Ds behind the lead vehicle 140 in the target lane 210. As one example, the first computer 110 can select the second fuel consumption value from a plurality of second fuel consumption values, e.g., stored in a look-up table or the like, corresponding to parameters, e.g., height relative to the host vehicle 105, speed, etc., of the lead vehicle 140 and host vehicle 105. The second fuel consumption values can be determined empirically, e.g., by making multiple measurements of a vehicle operating at multiple distances behind respective lead vehicles 140 operating at various speeds. As another example, the second fuel consumption value can be determined as a function of the height of the lead vehicle 140 (e.g., relative to the height of the host vehicle 105), the speed of the lead vehicle 140, and the specified distance Ds.

The first computer 110 can then compare the first fuel consumption value to the second fuel consumption value. When the second fuel consumption value is greater than the first fuel consumption value, the first computer 110 can be programmed to update the host vehicle 105 operation to draft behind the lead vehicle 140. When the second fuel consumption value is less than or equal to the first fuel consumption value, the first computer 110 can be programmed to maintain the host vehicle 105 operation. A second fuel consumption value is “greater” than a first fuel consumption value when the second fuel consumption value is larger than the first fuel consumption value, e.g., 20 mpg is greater than 18 mpg. Similarly, the second fuel consumption is “less” than the first fuel consumption value when the second fuel consumption is smaller than the first fuel consumption value, e.g., 18 mpg is lower than 20 mpg and 18 mpg is below 20 mpg.

Alternatively, the first computer 110 can determine a difference between the first and second fuel consumption values, e.g., by subtracting the first fuel consumption value from the second fuel consumption value. The first computer 110 can then compare the difference to a fuel consumption threshold. The fuel consumption threshold specifies a minimum increase in fuel consumption to allow the first computer 110 to operate the host vehicle 105 to draft behind the lead vehicle 140. The fuel consumption threshold may be a predetermined value (e.g., specified by a vehicle or component manufacturer), or a percentage of the first fuel consumption value. When the difference is less than the fuel consumption threshold, the first computer 110 can be programmed to maintain the host vehicle 105 operation. When the difference is greater than or equal to the fuel consumption threshold, the first computer 110 can be programmed to update the host vehicle 105 operation to draft behind the lead vehicle 140.

The first computer 110 can be programmed to move the host vehicle 105 to the specified distance Ds behind the lead vehicle 140 in the target lane 210, e.g., upon determining the second fuel consumption value is greater than the first fuel consumption value. For example, the first computer 110 can actuate one or more host vehicle components 125 to move the host vehicle 105 to the specified distance Ds behind the lead vehicle 140 in the target lane 210 (see FIG. 2C). In the situation that the target lane 210 and the current lane 205 are different lanes (as shown in FIG. 2A), the first computer 110 can determine a path, e.g., using path planning algorithms, to move the host vehicle 105 into the target lane 210. In the situation that the target lane 210 and the current lane 205 are the same lane (as shown in FIG. 2B), the first computer 110 can maintain the path of the host vehicle 105 in the current lane 205. Additionally, the first computer 110 can adjust the speed of the host vehicle 105, e.g., based on a speed of the lead vehicle 140, to maintain the host vehicle 105 at the specified distance Ds behind the lead vehicle 140 in the target lane 210.

While drafting behind the lead vehicle 140, the first computer 110 can predict a path of the lead vehicle 140. For example, the first computer 110 can predict the path of the lead vehicle 140 based on sensor 115 data. In such an example, the first computer can predict the lead vehicle 140 will change lanes based on a look-up table, e.g., stored in the memory of the first computer 110, that correlates actuation of lead vehicle 140 components to a lane change, such as an activated turn signal, the lead vehicle 140 moving toward a lane marking between one lane and another lane, the lead vehicle 140 reducing its speed, etc. For example, the first computer 110 can detect actuation of one or more lead vehicle 140 components via the sensor 115 data, e.g., by using image processing techniques. The first computer 110 can then predict the path based on the look-up table and the sensor 115 data. As another example, the first computer 110 can receive a planned path from the second computer 145, e.g., via V2V communications.

The first computer 110 can maintain operation of the host vehicle 105 to draft behind the lead vehicle 140 based on the path of the lead vehicle 140 matching the path of the host vehicle 105. Conversely, the first computer 110 can prevent the host vehicle 105 from drafting behind the lead vehicle 140 based on the path of the lead vehicle 140 diverging from the path of the host vehicle 105. In this situation, the first computer 110 can identify a new lead vehicle 140, as discussed above, for the host vehicle 105 to draft behind. Additionally, the first computer 110 can prevent the host vehicle 105 from drafting behind the lead vehicle 140 based on the speed of the lead vehicle decreasing below the first threshold (as discussed above) or increasing above the second threshold (as discussed above).

FIG. 3 is a diagram of an example deep neural network (DNN) 300 that can be trained to identify a lead vehicle 140 operating in front of a host vehicle 105 on a road 200 based on sensor 115 data from the host vehicle 105. The DNN 300 can be a software program that can be loaded in memory and executed by a processor included in a computer, for example. In an example implementation, the DNN 300 can include, but is not limited to, a convolutional neural network (CNN), R-CNN (Region-based CNN), Fast R-CNN, and Faster R-CNN. The DNN includes multiple nodes, and the nodes are arranged so that the DNN 300 includes an input layer, one or more hidden layers, and an output layer. Each layer of the DNN 300 can include a plurality of nodes 305. While FIG. 3 illustrate three (3) hidden layers, it is understood that the DNN 300 can include additional or fewer hidden layers. The input and output layers may also include more than one (1) node 305.

The nodes 305 are sometimes referred to as artificial neurons 305, because they are designed to emulate biological, e.g., human, neurons. A set of inputs (represented by the arrows) to each neuron 305 are each multiplied by respective weights. The weighted inputs can then be summed in an input function to provide, possibly adjusted by a bias, a net input. The net input can then be provided to an activation function, which in turn provides a connected neuron 305 an output. The activation function can be a variety of suitable functions, typically selected based on empirical analysis. As illustrated by the arrows in FIG. 3, neuron 305 outputs can then be provided for inclusion in a set of inputs to one or more neurons 305 in a next layer.

As one example, the DNN 300 can be trained with ground truth data, i.e., data about a real-world condition or state. For example, the DNN 300 can be trained with ground truth data and/or updated with additional data by a processor of the remote computer 150. Weights can be initialized by using a Gaussian distribution, for example, and a bias for each node 305 can be set to zero. Training the DNN 300 can include updating weights and biases via suitable techniques such as back-propagation with optimizations. Ground truth data can include, but is not limited to, data specifying objects, e.g., vehicles, pedestrians, etc., within an image or data specifying a physical parameter. For example, the ground truth data may be data representing objects and object labels. In another example, the ground truth data may be data representing an object, e.g., a vehicle, and a relative angle and/or speed of the object, e.g., the vehicle, with respect to another object, e.g., a pedestrian, another vehicle, etc.

During operation, the first computer 110 can obtain sensor 115 data including one or more vehicles operating in front of the host vehicle 105 (as discussed above) and provides the sensor 115 data to the DNN 300. The DNN 300 generates a prediction based on the received input. The output is an identification of a lead vehicle 140, e.g., from a plurality of vehicles operating in front of the host vehicle 105.

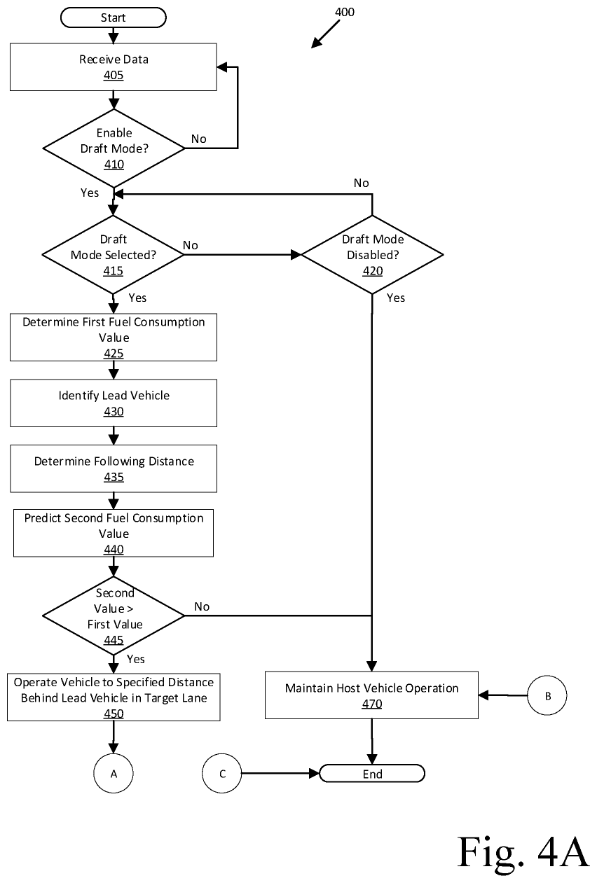

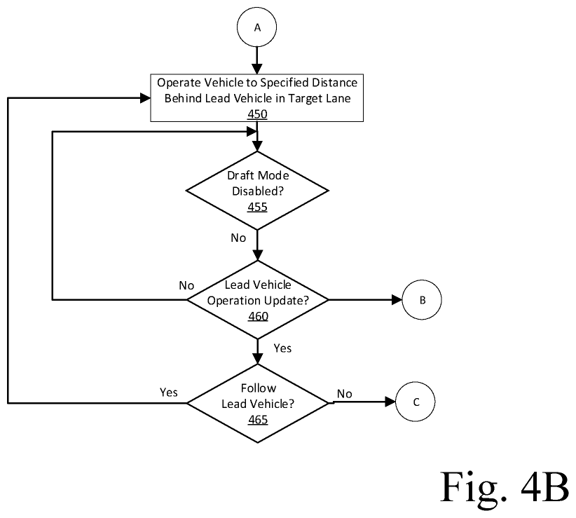

FIG. 4A is a first portion of a flowchart of an example process 400 (the second portion being shown in FIG. 4B because the entire flowchart will not fit on a single drawing sheet) for operating a host vehicle 105 to draft behind a lead vehicle 140 on a road 200. The process 400 begins in a block 405. The process 400 can be carried out by a first computer 110 included in the host vehicle 105 executing program instructions stored in a memory thereof.

In the block 405, the first computer 110 receives data from one or more sensors 115, e.g., via a vehicle network, from a remote server computer 150, e.g., via a network 135, and/or from a computer in another vehicle, e.g., via V2V communications. For example, the first computer 110 can receive image data, e.g., from one or more image sensors 115. The image data may include data about the environment around the host vehicle 105, e.g., another vehicle operating on the road 200, such as a lead vehicle 140 operating in front of the host vehicle 105, lane markings, etc. The first computer 110 can then identify a current lane 205, i.e., a lane of host vehicle 105 operation, based on the sensor 115 data, as discussed above. The process 400 continues in a block 410.

In the block 410, the first computer 110 determines whether to enable a draft operation mode of the host vehicle 105 to an enabled state. As set forth above, in the draft operation mode, the first computer 110 is programmed to operate the host vehicle 105 at a specified distance Ds behind a lead vehicle 140 in a target lane 210 such that the host vehicle 105 achieves an aerodynamic drafting effect from the lead vehicle 140. For example, the first computer 110 can transition the draft operation mode from a disabled state to the enabled state based on a speed of the host vehicle 105, as discussed above. For example, when the speed of the host vehicle 105 is between a first threshold (as discussed above) and a second threshold (as discussed above), the first computer 110 can transition the draft operation mode to the enabled state. Conversely, when the speed of the host vehicle 105 is less than or equal to the first threshold or greater than or equal to the second threshold, the first computer 110 can maintain the draft operation mode in the disabled state.

Additionally, or alternatively, the first computer 110 can transition the draft operation mode from the disabled state to the enabled state based on a traffic density of the road 200, as discussed above. For example, when the traffic density of the road 200 is less than a threshold density, the first computer 110 can transition the draft operation mode to the enabled state. Conversely, when the traffic density is greater than or equal to the threshold density, the first computer 110 can maintain the draft operation mode in the disabled state.

Additionally, or alternatively, the first computer 110 can transition the draft operation mode from the disabled state to the enabled state based on weather data, as discussed above. For example, when the weather data indicates an absence of precipitation, the first computer 110 can transition the draft operation mode to the enabled state. Conversely, when the weather data indicates a presence of precipitation, the first computer 110 can maintain the draft operation mode in the disabled state. If the first computer 110 transitions the draft operation mode to the enabled state, the process 400 continues in a block 415. Otherwise, the process 400 returns to the block 405.

In the block 415, the first computer 110 determines whether the draft operation mode is selected. For example, in the enabled state, the first computer 110 may actuate an HMI 118 to detect a first user input selecting the draft operation mode, as discussed above. In other words, the HMI 118 may activate sensors 115 that can detect the first user input, e.g., the user pressing a virtual button on a touchscreen display to select the draft operation mode. Upon detecting the first user input, the HMI 118 can provide the first user input to the first computer 110, and the first computer 110 can select the draft operation mode based on the first user input. If the first computer 110 receives the first user input selecting the draft operation mode, then the process 400 continues in a block 425. Otherwise, the process continues in a block 420.

In the block 420, the first computer 110 determines whether to disable the draft operation mode of the host vehicle 105 to the disabled state. For example, the first computer 110 can transition the draft operation mode from the enabled state to the disabled state based on a speed of the host vehicle 105, as discussed above. For example, when the speed of the host vehicle 105 is less than or equal to the first threshold or greater than or equal to the second threshold, the first computer 110 can transition the draft operation mode to the disabled state. Conversely, when the speed of the host vehicle 105 is between a first threshold and a second threshold, the first computer 110 can maintain the draft operation mode in the enabled state.

Additionally, or alternatively, the first computer 110 can transition the draft operation mode from the enabled state to the disabled state based on a traffic density of the road 200, as discussed above. For example, when the traffic density of the road 200 is greater than or equal to the threshold density, the first computer 110 can transition the draft operation mode to the disabled state. Conversely, when the traffic density is less than a threshold density, the first computer 110 can maintain the draft operation mode in the enabled state.

Additionally, or alternatively, the first computer 110 can transition the draft operation mode from the enabled state to the disabled state based on weather data, as discussed above. For example, when the weather data indicates a presence of precipitation, the first computer 110 can transition the draft operation mode to the disabled state. Conversely, when the weather data indicates an absence of precipitation, the first computer 110 can maintain the draft operation mode in the enabled state. If the first computer 110 transitions the draft operation mode to the disabled state, the process 400 continues in a block 470. Otherwise, the process 400 returns to the block 415.

In the block 425, the first computer 110 determines a first fuel consumption value operating the host vehicle 105 in the current lane 205. For example, the first computer 110 can measure, e.g., via sensor 115 data, an amount of fuel consumed while operating in the current lane 205 and divide the amount of fuel consumed by the distance traveled in the current lane 205 while measuring the fuel consumption, as discussed above. The process 400 continues in a block 430.

In the block 430, the first computer 110 identifies a vehicle 215 operating on the road 200 as a lead vehicle 140. As set forth above, a lead vehicle 140 is a vehicle operating on the road 200 and in front of the host vehicle 105. For example, the first computer 110 can identify a vehicle 215 operating on the road 200 based on sensor 115 data, e.g., image data, as discussed above. Additionally, the first computer 110 can determine a longitudinal position of the identified vehicle 215 relative to the host vehicle 105 based on sensor 115 data, as discussed above. The first computer 110 can then identify the identified vehicle 215 as a lead vehicle 140 based on the longitudinal position of the identified vehicle 215 relative to the host vehicle 105, as discussed above.

Additionally, or alternatively, upon identifying the vehicle 215 via sensor 115 data, the first computer 110 can identify the identified vehicle 215 as a lead vehicle 140 based on a speed of the identified vehicle 215. For example, the first computer 110 can determine the speed of the identified vehicle 215 based on sensor 115 data, as discussed above. Alternatively, the first computer 110 can receive the speed of the identified vehicle 215 from the vehicle, e.g., via V2V communications. The first computer 110 can then compare the speed of the identified vehicle 215 to the first and second thresholds. If the speed of the identified vehicle 215 is between the first and second thresholds, then the first computer 110 can identify the identified vehicle 215 as a lead vehicle 140.

Additionally, or alternatively, the first computer 110 can identify the identified vehicle 215 as a lead vehicle 140 based on a height of the identified vehicle 215. For example, the first computer 110 can determine the height of the identified vehicle 215 based on sensor 115 data, as discussed above. Alternatively, the first computer 110 can receive the height of the identified vehicle 215 from the identified vehicle 215, e.g., via V2V communications. The first computer 110 can then compare the height of the identified vehicle 215 to the height of the host vehicle 105, e.g., stored in a memory of the first computer 110. If the height of the identified vehicle 215 is greater than or equal to the height of the host vehicle 105, then the first computer 110 can identify the identified vehicle 215 as a lead vehicle 140.

Additionally, or alternatively, the first computer 110 can identify the identified vehicle 215 as a lead vehicle 140 based on a number of lanes between a target lane 210, i.e., a lane in which the identified vehicle 215 is operating, and the current lane 205, i.e., a lane in which the host vehicle 105 is operating. As set forth above, the target lane 210 can be a same or different lane than the current lane 205. For example, the first computer 110 can identify the target lane 210 and determine a number of lanes between the target lane 210 and current lane 205 based on sensor 115 data, as discussed above. The first computer 110 can then compare the number of lanes between the target lane 210 and the current lane 205 to a threshold (as discussed above). If the number of lanes between the target lane 210 and the current lane 205 is less than the threshold, the first computer 110 can identify the identified vehicle 215 as a lead vehicle 140.

Additionally, or alternatively, the first computer 110 can identify the identified vehicle 215 as a lead vehicle 140 based on a distance D from the host vehicle 105 to the identified vehicle 215. For example, the first computer 110 can determine the distance D from the host vehicle 105 to the identified vehicle 215 based on sensor 115 data, as discussed above. The first computer 110 can then compare the distance D to a threshold distance (as discussed above). If the distance D is less than or equal to the threshold distance, then the first computer 110 can identify the identified vehicle 215 as a lead vehicle 140.

Additionally, or alternatively, the first computer 110 can identify the identified vehicle 215 as a lead vehicle 140 based on a gap G between the identified vehicle 215 and another vehicle immediately behind the identified vehicle 215 and in the target lane 210. For example, the first computer 110 can determine the gap G based on sensor 115 data, as discussed above. The first computer 110 can then compare the gap G to a threshold gap (as discussed above). If the gap G is greater than or equal to the threshold gap, then the first computer 110 can identify the identified vehicle 215 as a lead vehicle 140.

As another example, the first computer 110 can input sensor 115 data, e.g., image data including the identified vehicle 215, into a DNN 300 that can be trained to accept image data for an identified vehicle 215 as input. The DNN 300 can then generate an output identifying the identified vehicle 215 as a lead vehicle 140.

In the case that the first computer 110 identifies a plurality of lead vehicles 140, the first computer 110 can select one lead vehicle 140 based on Equation 2, as discussed above. The process 400 continues in a block 435.

In the block 435, the first computer 110 determines a specified distance Ds at which to travel behind the lead vehicle 140 in the target lane 210. As set forth above, the specified distance Ds is a distance at which the host vehicle 105 can achieve an aerodynamic drafting effect while operating behind the lead vehicle 140. For example, the first computer 110 can determine the specified distance Ds based on Equation 3, as discussed above. The process 400 continues in a block 440.

In the block 440, the first computer 110 predicts a second fuel consumption value for operating the host vehicle 105 at the specified distance Ds behind the lead vehicle 140 in the target lane 210, i.e., drafting behind the lead vehicle 140. For example, the first computer 110 can predict the second fuel consumption value based on a look-up table that corresponds the second fuel consumption value to parameters, e.g., height, speed, etc., of the lead vehicle 140 and the host vehicle 105, as discussed above. The process 400 continues in a block 445.

In the block 445, the first computer 110 determines whether the second fuel consumption value is greater than the first fuel consumption value. For example, the first computer 110 can compare the first fuel consumption value to the second fuel consumption value. As set forth above, a second fuel consumption value is “greater” than a first fuel consumption value when the second fuel consumption value is larger than the first fuel consumption value, e.g., 20 mpg is greater than 18 mpg. If the second fuel consumption value is greater than the first fuel consumption value, then the process 400 continues in a block 450. Otherwise, the process 400 continues in the block 470.

Alternatively, the first computer 110 can determine a difference between the first and second fuel consumption values, e.g., by subtracting the first fuel consumption value from the second fuel consumption value. The first computer 110 can then compare the difference to a fuel consumption threshold (as discussed above). If the difference is greater than or equal to the fuel consumption threshold, the process 400 continues in the block 450. Otherwise, the process 400 continues in the block 470.

Turning now to FIG. 4B, following the block 445 shown in FIG. 4A, in the block 450, the first computer 110 operates the host vehicle 105 at the specified distance Ds behind the lead vehicle 140 in the target lane 210. For example, the first computer 110 can determine a path from a current position of the host vehicle 105 to the specified distance Ds behind the lead vehicle 140 in the target lane 210, as discussed above. The first computer 110 can then actuate one or more vehicle components 125 to move the host vehicle 105 along the path to the specified distance Ds behind the lead vehicle 140 in the target lane 210. The process 400 continues in a block 455.

In the block 455, the first computer 110 determines whether to transition the draft operation mode to the disabled state. The block 455 is substantially the same as the block 420 of process 400 and therefore will not be described further to avoid redundancy. If the first computer 110 transitions the draft operation mode to the disabled state, the process 400 continues in a block 470. Otherwise, the process 400 continues in a block 460.

In the block 460, the first computer 110 determines whether a path of the lead vehicle 140 has updated. For example, the first computer 110 can determine the path of the lead vehicle 140 based on sensor 115 data, as discussed above. As another example, the first computer 110 can receive the path of the lead vehicle 140 from a second computer 145 included in the lead vehicle 140, e.g., via V2V communications. If the first computer 110 determines that the path of the lead vehicle 140 has updated, then the process 400 continues in a block 465. Otherwise, the process 400 returns to the block 455.

In the block 465, the first computer 110 determines whether to follow the lead vehicle 140, i.e., continue drafting behind the lead vehicle 140. For example, the first computer 110 can compare the updated path of the lead vehicle 140 to the path of the host vehicle 105, as discussed above. If the updated path of the lead vehicle 140 matches the path of the host vehicle 105, then the process 400 returns to the block 450. Otherwise, the first computer 110 determines to not follow the lead vehicle 140 and the process 400 ends following the block 465.

In the block 470, the first computer 110 maintains the operation of the host vehicle 105 in the current lane 205. That is, the first computer 110 continues to operate the host vehicle 105 in the current lane 205 such that the host vehicle 105 does not draft behind a lead vehicle 140. For example, the first computer 110 may actuate one or more host vehicle components 125 to maintain at least a following distance Df behind a lead vehicle 140 operating in the current lane 205. As set forth above, the following distance Df may be greater than the specified distance Ds, such that the host vehicle 105 does not achieve an aerodynamic drafting effect when operating at the following distance Df behind a lead vehicle 140. The process 400 ends following the block 470.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a first computer including a processor and a memory, the memory storing instructions executable by the processor to:
determine a first fuel consumption value for operating a host vehicle in a current lane on a road;
identify a lead vehicle operating in front of the host vehicle and in a target lane on the road based on a speed of the lead vehicle being greater than a first threshold and less than or equal to a second threshold, wherein the second threshold is greater than the first threshold;
predict a second fuel consumption value for operating the host vehicle at a specified distance behind the lead vehicle in the target lane based on the speed of the lead vehicle; and
operate the host vehicle at the specified distance behind the lead vehicle in the target lane based on the predicted second fuel consumption value being greater than the first fuel consumption value.

2. The system of claim 1, wherein the instructions further include instructions to predict the second fuel consumption value additionally based on a height of the lead vehicle.

3. The system of claim 1, wherein the instructions further include instructions to identify the lead vehicle additionally based on a height of the lead vehicle.

4. The system of claim 1, wherein the instructions further include instructions to identify the lead vehicle additionally based on a distance from the host vehicle to the lead vehicle.

5. The system of claim 1, wherein the instructions further include instructions to identify the lead vehicle additionally based on a gap between the lead vehicle and a vehicle in the target lane and immediately behind the lead vehicle.

6. The system of claim 1, wherein the instructions further include instructions to identify the lead vehicle additionally based on a number of lanes between the current lane and the target lane.

7. The system of claim 1, wherein the instructions further include instructions to input host vehicle sensor data into a machine learning program that identifies the lead vehicle.

8. The system of claim 1, wherein the instructions further include instructions to determine the specified distance based on the speed of the lead vehicle.

9. The system of claim 1, wherein the instructions further include instructions to determine the specified distance based on weather data.

10. The system of claim 1, wherein the instructions further include instructions to determine the specified distance based on receiving a user input in the host vehicle.

11. The system of claim 1, wherein the instructions further include instructions to enable a draft operation mode to an enabled state based on determining a speed of the host vehicle is greater than the first threshold and less than or equal to the second threshold.

12. The system of claim 11, wherein the instructions further include instructions to operate the host vehicle the specified distance behind the lead vehicle in the target lane additionally based on receiving a user input in the host vehicle selecting the draft operation mode.

13. The system of claim 12, wherein the instructions further include instructions to update host vehicle operation based on receiving another user input deselecting the draft operation mode.

14. The system of claim 11, wherein the instructions further include instructions to enable the draft operation mode to the enabled state additionally based on weather data.

15. The system of claim 11, wherein the instructions further include instructions to enable the draft operation mode to the enabled state additionally based on a traffic density on the road being below a threshold density.

16. A method, comprising:
determining a first fuel consumption value for operating a host vehicle in a current lane on a road;
identifying a lead vehicle operating in front of the host vehicle and in a target lane on the road based on a speed of the lead vehicle being greater than a first threshold and less than or equal to a second threshold, wherein the second threshold is greater than the first threshold;
predicting a second fuel consumption value for operating the host vehicle at a specified distance behind the lead vehicle in the target lane based on the speed of the lead vehicle; and
operating the host vehicle at the specified distance behind the lead vehicle in the target lane based on the predicted second fuel consumption value being greater than the first fuel consumption value.

17. The method of claim 16, further comprising predicting the second fuel consumption value additionally based on a height of the lead vehicle.

18. The method of claim 16, further comprising identifying the lead vehicle additionally based on at least one of a height of the lead vehicle, a distance from the host vehicle to the lead vehicle, a gap between the lead vehicle and a vehicle in the target lane and immediately behind the lead vehicle, or a number of lanes between the current lane and the target lane.

19. The method of claim 16, further comprising determining the specified distance based on at least one of the speed of the lead vehicle, weather data, or receiving a user input in the host vehicle.

20. The method of claim 16, further comprising inputting host vehicle sensor data into a machine learning program that identifies the lead vehicle.
